(19) United States
(12) Patent Application Publication
(10) Pub. No.: US 2013/0070166 A1
(43) Pub. Date: Mar. 21, 2013

(54) LIGHTING DEVICE, DISPLAY DEVICE AND TELEVISION DEVICE

(71) Applicant: Tatsuro Kuroda, Osaka (JP)

(72) Inventor: Tatsuro Kuroda, Osaka (JP)

(73) Assignee: SHARP KABUSHIKI KAISHA, Osaka (JP)

(21) Appl. No.: 13/701,891

(22) PCT Filed: Apr. 21, 2011
(86) PCT No.: PCT/JP2011/059793

§ 371 Date: Dec. 4, 2012

(30) Foreign Application Priority Data
Jun. 18, 2010 (JP) 2010-139462

(51) Int. Cl. F21V 21/00; H04N 7/00

(52) U.S. Cl. CPC F21V 21/00; H04N 7/00
USPC 348/739; 362/217.15; 362/225

(57) ABSTRACT

An object of the present invention is to provide a lighting device in which a tubular light source is less likely to be damaged. A backlight unit (lighting device) according to the present invention includes a cold cathode fluorescent tube (CCFT) (tubular light source) including an outer lead (external connecting portion) at an end portion thereof, a chassis housing the CCFT, a connector (connector) attached to an end section of the chassis and electrically connected to the outer lead, a lamp clip (light source holder) mounted on a middle section of the chassis, and a reinforcing portion provided on at least an area extending from the connector to the lamp clip adjacent to the connector. The connector and the lamp clip hold an end portion and a middle portion of the CCFT, respectively.

### TECHNICAL FIELD

The present invention relates to a lighting device, a display device, and a television device.

### BACKGROUND ART

A liquid crystal panel used for a liquid crystal display device such as a liquid crystal television does not emit light, and thus a backlight unit is required as a separate lighting device. The backlight unit is provided behind the liquid crystal panel (on aside opposite to a display surface). The backlight unit includes a chassis, a plurality of cold cathode fluorescent tubes housed in the chassis, a plurality of optical members (a diffuser sheet and the like), an inverter board, and a connector. The chassis has an opening on a side of the liquid crystal panel. The cold cathode fluorescent tubes each have an electrode at its ends. The optical members are provided over the opening of the chassis for efficiently releasing lights emitted from the cold cathode fluorescent tubes toward the liquid crystal panel. The inverter is capable of supplying power to each cold cathode fluorescent tube. The connector electrically connects the cold cathode fluorescent tube and the inverter board. One example of the backlight unit having such a configuration is disclosed in Patent Document 1.

### RELATED ART DOCUMENT

### Patent Document

Patent Document 1: Japanese Unexamined Patent Publication No. 2009-93156

### PROBLEM TO BE SOLVED BY THE INVENTION

In the backlight unit having the above configuration, if large force acts on an end section of a chassis on which a cold cathode fluorescent tube is mounted, the end section of the chassis may be deformed and displaced toward a middle section of the chassis. This may damage or break the cold cathode fluorescent tube.

### DISCLOSURE OF THE PRESENT INVENTION

The present invention was made in view of the above circumstances. It is an object of the present invention to provide a lighting device in which a tubular light source is hardly or less likely to be damaged.

### MEANS FOR SOLVING THE PROBLEM

A lighting device according to the present invention includes a tubular light source including an external connecting portion at an end portion thereof, a chassis housing the tubular light source and including an end section and a middle section, a connector attached to the end section of the chassis and electrically connected to the external connecting portion, a light source holder mounted on the middle section of the chassis, and a reinforcing portion provided on at least an area extending from the connector to the light source holder adjacent to the connector. The connector holds an end portion of the tubular light source. The light source holder holds a middle portion of the tubular light source.

In this configuration, the end portion of the tubular light source including the external connecting portion is held by the connector and the middle portion of the tubular light source is held by the light source holder. If force acts on the chassis and the end section on which the connector is arranged and the middle section on which the light source holder is arranged are displaced, the chassis may be deformed. In such a case, the deformation of the tubular light source with the deformation of the chassis is restricted, because the end portion and the middle portion of the tubular light source are held by the connector and the light source holder, respectively. This may result in a stress concentration particularly on a portion of the tubular light source held by the light source holder, and the tubular light source may be damaged at the portion.

According to the present invention, the reinforcing portion is arranged to extend at least from the connector to the light source holder adjacent to the connector. With this configuration, if the force described above acts on the chassis, the deformation is less likely to occur in an area of the chassis between the connector and the light source holder adjacent to the connector. This can reduce the stress concentration on the portion of the tubular light source held by the light source holder adjacent to the connector, and thus the tubular light source is less likely to be damaged.

The following configurations are preferable as embodiments of the present invention.

(1) The chassis integrally includes the reinforcing portion by protruding a part of the chassis. With this configuration, the reinforcing portion can be integrally formed with the chassis. Compared with a case that the reinforcing portion is a separate member from the chassis, the chassis can be properly reinforced and the cost can be reduced.

(2) The reinforcing portion may protrude toward a side opposite to the tubular light source. With this configuration, in the assembling operation of the lighting device, the reinforcing portion protruding toward the side opposite to the tubular light source can be placed on a work table. Thus, the work table can receive the force acts on the chassis during the assembling operation through the reinforcing portion, for example.

(3) The reinforcing portion may have an elongated shape, and a long-side direction of the reinforcing portion may match an axial direction of the tubular light source. With this configuration, the chassis can be properly reinforced, and thus the tubular light source is less likely to be damaged.

(4) The reinforcing portion may overlap at least a part of the tubular light source in a plan view. With this configuration, the chassis can be effectively reinforced and the tubular light source is less likely to be damaged compared with the case that the reinforcing portion does not overlap the tubular light source in a plan view. Further, if parasitic capacitance exits between the tubular light source and the chassis, the parasitic capacitance is less likely to change because the deformation of the portion of the chassis overlapping the part of the tubular light source is reduced by the reinforcing portion. Thus, the brightness of the tubular light source can be stabilized.

(5) The reinforcing portion may have a width that is larger than a diameter of the tubular light source. With this configuration, the chassis is further less likely to be deformed, and thus the tubular light source is further less likely to be damaged.

(6) The reinforcing portion may overlap at least a part of the light source holder adjacent to the connector in a plan view. With this configuration of the reinforcing portion, a part of the chassis around the light source holder is less likely to be deformed, and thus the part of the tubular light source held by the light source holder is less likely to be damaged.

(7) The reinforcing portion may overlap at least apart of the connector in a plan view. With this configuration of the reinforcing portion, the part of the chassis around the connector is less likely to be deformed, and thus the portion of the tubular light source held by the connector is less likely to be damaged.

(8) The reinforcing portion extends from the connector beyond the light source holder adjacent to the connector. With this configuration of the reinforcing portion, a portion of the chassis around the light source holder is less likely to be deformed, and thus the portion of the tubular light source held by the light source holder is less likely to be damaged.

(9) The reinforcing portion extends from a position closer to an end of the chassis than the connector to the light source holder adjacent to the connector. With this configuration of the reinforcing portion, the part of the chassis around the connector is less likely to be deformed, and thus the part of the tubular light source held by the connector is less likely to be damaged.

(10) The tubular light source may include the external connecting portion at each end portion thereof. The connector may include two connectors, and the connectors may be mounted to the chassis at positions corresponding to the external connecting portions, respectively. The reinforcing portion may extend from one of the connectors to the other one of the connectors. With this configuration of the reinforcing portion, the chassis is less likely to be damaged over the area between one of the connectors and the other one of the connectors, i.e., the area over substantially the entire length of the tubular light source, and thus the tubular light source is less likely to be damaged over substantially the entire length.

(11) The connector may include a housing and a connection terminal. The housing may include a light source receiving portion receiving the tubular light source. The connection terminal may be arranged in the housing so as to be in contact with the external connecting portion. With this configuration, the external connecting portion contacts with the connection terminal when the end portion of the tubular light source is housed in the light source receiving portion of the housing.

(12) The light source receiving portion may have an opening and the connector may further include a lid configured to close the opening. With this configuration, by closing the light source receiving portion with the lid after the end portion of the tubular light source is housed in the light source receiving portion, the tubular light source is less likely to drop off. When the light source receiving portion is closed with the lid, a large force may act on the end section of the chassis where the connector is arranged. However, in this configuration, even if the large force acts on the end section, the portion of the chassis where the reinforcing portion is arranged is less likely to be deformed, and thus the tubular light source is less likely to be damaged.

(13) The housing may integrally include the lid. With this configuration, the number of components can be reduced compared with the case that the lid and the housing are separate members. This facilitates parts management.

(14) The lighting device may further include a power supply board electrically connected to the connector so as to supply power to the tubular light source. The power supply board may have a plate surface that is attached to the reinforcing portion. With this configuration, the chassis is secondarily reinforced by the power supply board, and thus the tubular light source is less likely to be damaged.

(15) The power supply board may be fixed on the reinforcing portion. With this configuration, the power supply board can be fixed through the reinforcing portion.

(16) The tubular light source may include a plurality of tubular light sources. The tubular light sources may be arranged in the chassis such that the axes thereof are arranged to be parallel to each other. The light source holder may include a main body and a plurality of light source gripping portions. The main body may extend in a direction intersecting with an axis of each of the tubular light sources. The light gripping portions may protrude from the main body toward the tubular light sources and grip the tubular light sources. With this configuration, each light source gripping portion of the light source holders can grip each tubular light source, and thus each tubular light source can be held.

(17) The reinforcing portion may include a plurality of reinforcing portions. Each of the reinforcing portions may be arranged to correspond to each tubular light source and extend along the axial direction of the tubular light sources. The chassis may include a mounting hole between the reinforcing portions adjacent to each other. The main body of the light source holder may be provided with a mounting portion. The mounting portion is inserted into the mounting hole such that an edge of the mounting hole is sandwiched between the main body and the mounting portion. In this configuration, when the mounting portion is inserted into the mounting hole between the reinforcing portions adjacent to each other, the edge of the mounting hole can be sandwiched between the main body and the mounting portion, and thus the light source holder can be attached to the chassis.

(18) The lighting device may further include a cover member attached to the chassis. The cover member may cover the connector and the end portion of the tubular light source. With this configuration, the connector and the end portion of the tubular light source can be covered with the cover member, and thus the connector and the end portion are less likely to be recognized as dark portions. When the cover member is attached to the chassis, a large force may act on the end section of the chassis where the connector is arranged. However, in this configuration, even if the large force acts on the end section, the portion of the chassis where the reinforcing portion is arranged is less likely to be deformed, and thus the tubular light source is less likely to be damaged.

(19) The tubular light source may include a plurality of tubular light sources. The tubular light sources may be arranged in the chassis such that axes thereof are arranged parallel to each other. The connector may include a plurality of connectors. The connectors may be arranged at positions corresponding to end portions of the tubular light sources. The cover member may be arranged to extend along a direction intersecting with an axis of each of the tubular light sources and collectively cover the connectors and the end portions of the tubular light sources. With this configuration, the connectors and the end portions of the tubular light sources can be covered with the cover member arranged to extend along the direction intersecting with the axes of the tubular light sources. This facilitates the assembling operation of the lighting device.

(20) The tubular light source may be a cold cathode fluorescent tube. With this configuration, a service life of the light source can be longer and control of light can be easily performed.

Next, to solve the above problem, a display device according to the present invention may include the above-described lighting device and a display panel configured to provide display using light from the lighting device.

According to such a display device, in the lighting device supplying the light to the display panel, the tubular light source is less likely to be damaged, and thus the production cost can be reduced.

The display panel may be a liquid crystal panel. The display device as a liquid crystal display device has a variety of applications, such as a television display or a personal-computer display. Particularly, it is suitable for a large screen display.

### ADVANTAGEOUS EFFECT OF THE INVENTION

According to the present invention, the tubular light source is hardly or less likely to be damaged.

### BRIEF DESCRIPTION OF THE DRAWINGS

FIG. 1 is an exploded perspective view of a general construction of a television device according to the first embodiment of the present invention;

FIG. 2 is an exploded perspective view illustrating a general configuration of a liquid crystal display device included in the television device;

FIG. 3 is a cross-sectional view of the liquid crystal display device taken along a long-side direction thereof;

FIG. 4 is a cross-sectional view of the liquid crystal display device taken along a short-side direction thereof;

FIG. 5 is a plan view illustrating an arrangement of cold cathode fluorescent tubes and connectors in the chassis included in the liquid crystal display device;

FIG. 6 is a bottom view of the chassis included in the liquid crystal display device;

FIG. 7 is a magnified cross-sectional view of a lamp clip, a connector, and a reinforcing portion;

FIG. 8 is a cross-sectional view illustrating a state before the cold cathode fluorescent tube is housed in the chassis;

FIG. 9 is a magnified cross-sectional view illustrating a state before the cold cathode fluorescent tube is housed in the chassis;

FIG. 10 is a magnified cross-sectional view illustrating a state in which the cold cathode fluorescent tube is housed in the chassis;

FIG. 11 is a magnified cross-sectional view illustrating a lamp clip, a connector, and reinforcing portion according to the second embodiment of the present invention;

FIG. 12 is a bottom view of the chassis;

FIG. 13 is a cross-sectional view of the liquid crystal display device according to the third embodiment of the present invention taken along the long-side direction;

FIG. 14 is a bottom view of the chassis;

FIG. 15 is a magnified cross-sectional view of a lamp clip, a connector, and an inverter board (a reinforcing portion) according to the fourth embodiment of the present invention; and

FIG. 16 is a magnified cross-sectional view illustrating a state before the cold cathode fluorescent tube is housed in the chassis.

### BEST MODE FOR CARRYING OUT THE INVENTION

### First Embodiment

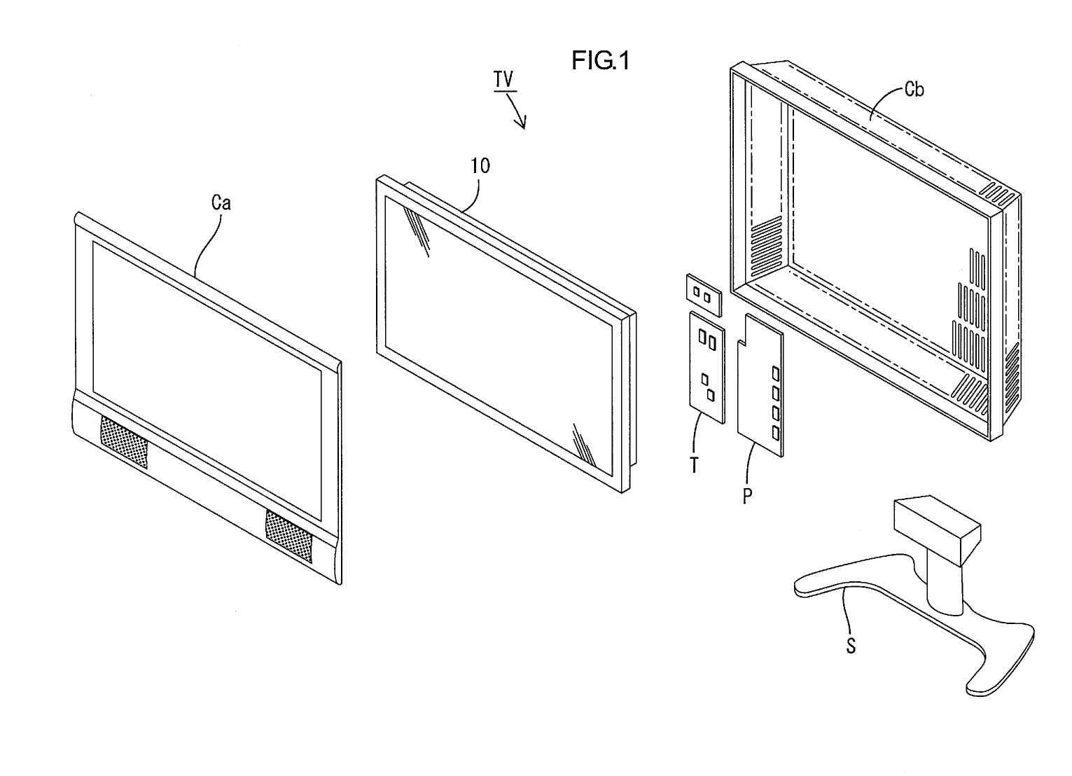

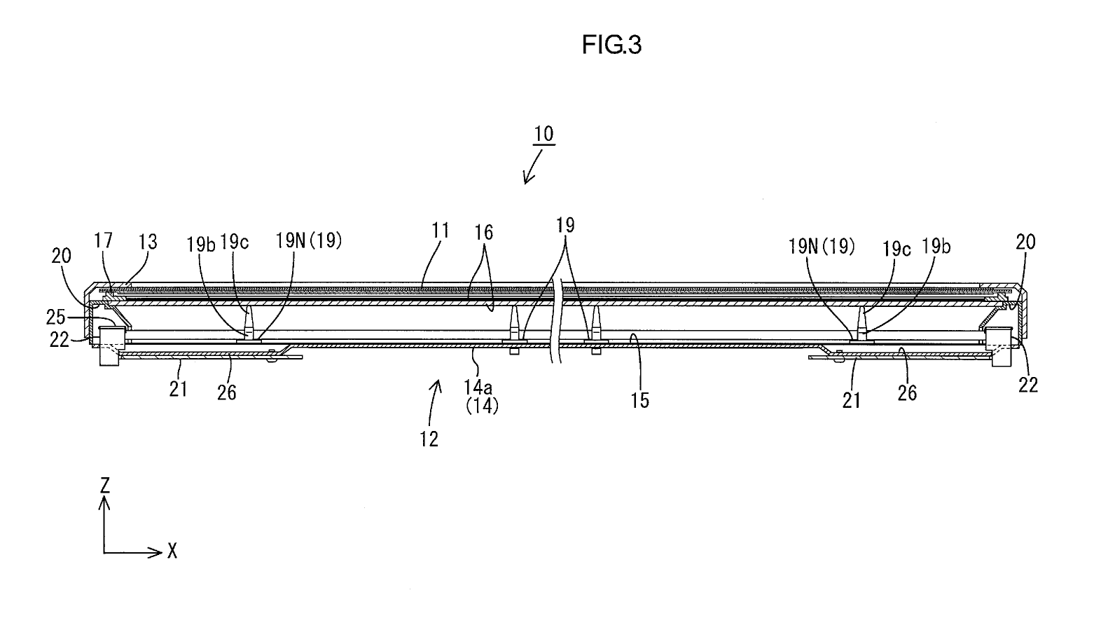

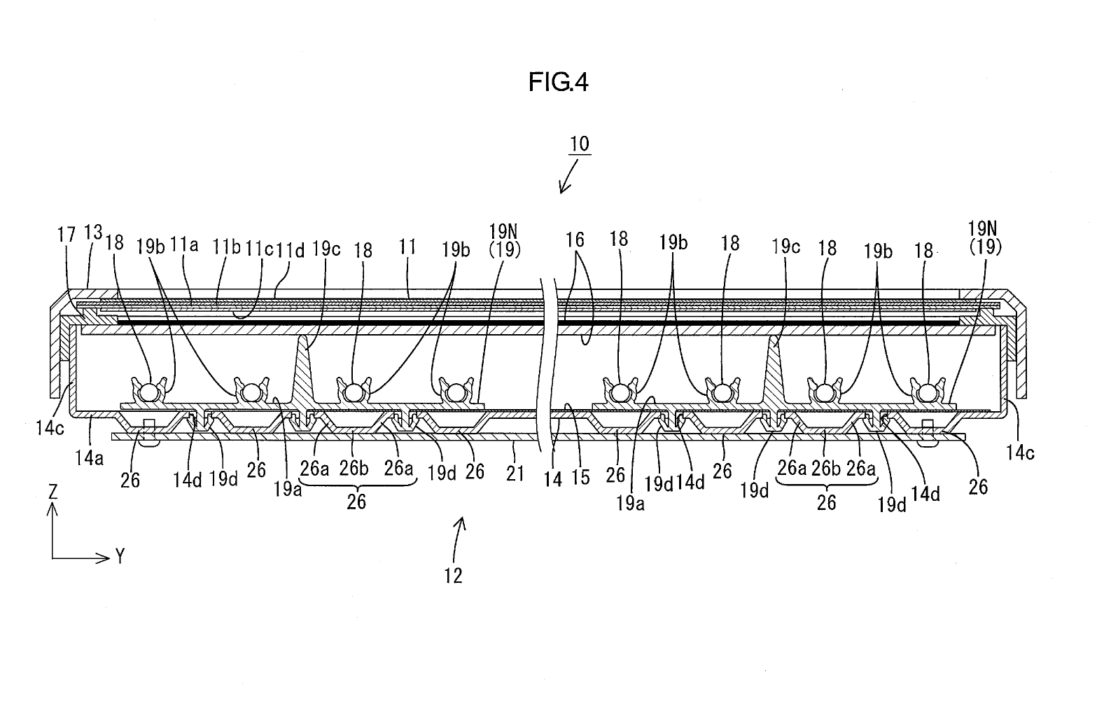

The first embodiment of the present invention will be described with reference to FIG. 1 to FIG. 10. In the present embodiment, a liquid crystal display device 10 will be explained. An X-axis, a Y-axis and a Z-axis are described in a part of the drawings, and a direction of each axial direction corresponds to a direction described in each drawing. An upper side in FIG. 3 and FIG. 4 corresponds to a front side and a lower side in FIG. 3 and FIG. 4 corresponds to a rear side.

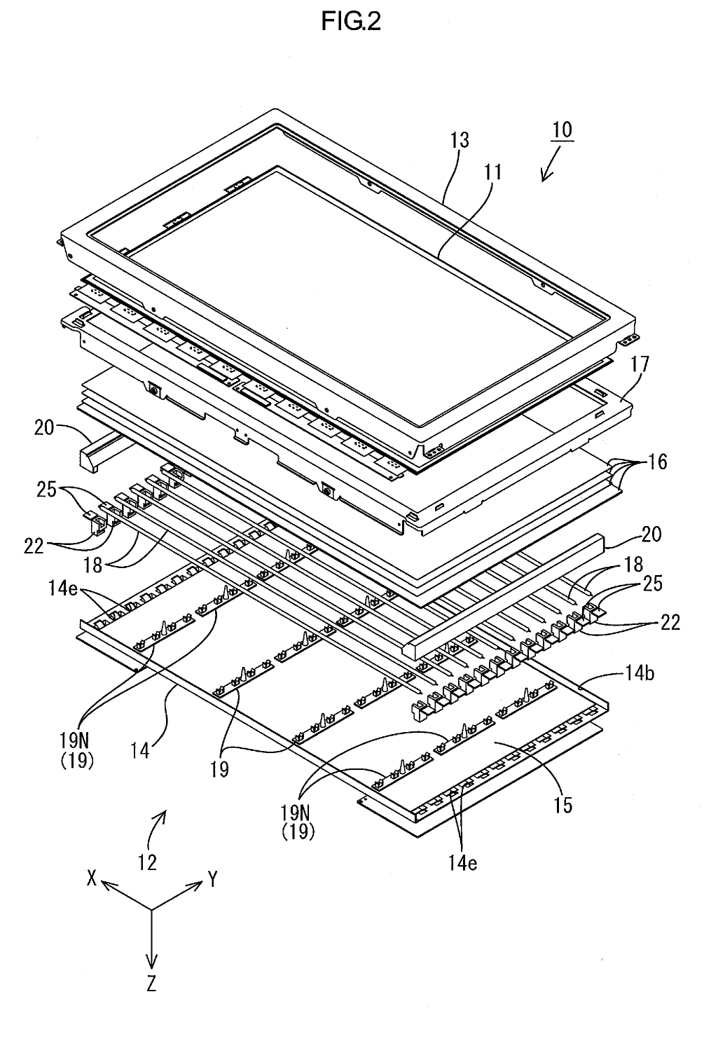

As illustrated in FIG. 1, the television device TV of the present embodiment includes the liquid crystal display device (a display device) 10, front and rear cabinets Ca, Cb which house the liquid crystal display device 10 therebetween, a power source P, a tuner T and a stand S. The liquid crystal display device 10 has a landscape rectangular shape as a whole. As illustrated in FIG. 2, the liquid crystal display device 10 includes a liquid crystal panel 11 as a display panel, and a backlight unit (a lighting device) 12 as an external light source. The liquid crystal panel 11 and the backlight unit 12 are integrally held by a frame shaped bezel 13 and the like.

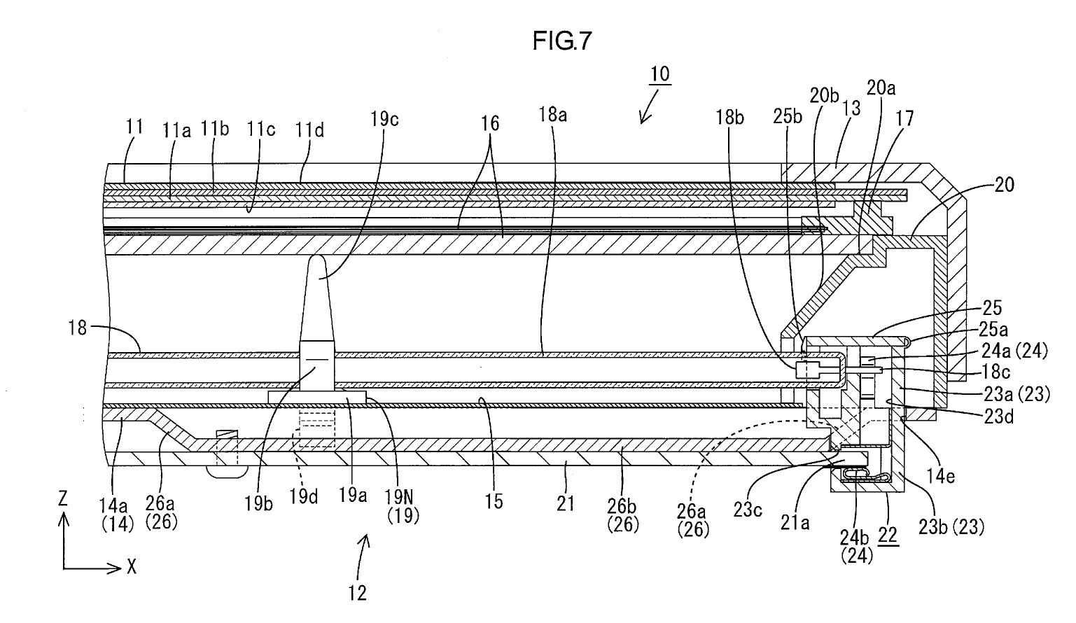

Next, the liquid crystal panel 11 and the backlight unit 12 included in the liquid crystal display device 10 will be sequentially explained. The liquid crystal display device 11 has a landscape rectangular shape in a plan view (an elongated shape including a long side extending along the X-axis direction). As illustrated in FIG. 3, FIG. 4, and FIG. 7, the liquid crystal panel 11 is configured such that a pair of glass substrates 11a, 11b is bonded together with a predetermined gap therebetween and liquid crystal (not illustrated) is sealed between the glass substrates 11a, 11b. On one of the glass substrates 11a, switching components (for example, TFTs) connected to source lines and gate lines which are perpendicular to each other, pixel electrodes connected to the switching components, an alignment film, and the like are provided. On the other glass substrate 11b, color filters having color sections such as red (R), green (G), and blue (B) color sections arranged in a predetermined pattern, counter electrodes, an alignment film, and the like are provided. Image data and various control signals that are necessary to display an image are supplied to the source lines, the gate lines, the counter electrodes, and the like from a drive circuit board which is not illustrated. Polarizing plates 11c, 11d are arranged on outer surfaces of the glass substrates 11a, 11b.

As illustrated in FIG. 2 and FIG. 3, the backlight unit 12 is a direct type backlight unit in which the light sources are arranged right behind the liquid crystal panel 11. The backlight unit 12 includes a chassis 14, a reflection sheet 14, optical member 16, a frame 17, cold cathode fluorescent tubes (tubular light sources) 18, connectors 22, lamp clips 19, lamp holders 20, and an inverter board (a power supply board) 21. The chassis 14 has a box-like shape with an opening on a front side (the light exit side, the liquid crystal panel 11 side). The reflection sheet 15 is arranged in the chassis 14. The optical member 16 is arranged to cover an opening 14b of the chassis 14. The frame 17 holds the optical member 16. The cold cathode fluorescent tubes 18 are aligned and housed in the chassis 14. The connectors 22 each hold end portions of the cold cathode fluorescent tubes 18. The lamp clips 19 each hold middle portions of the cold cathode fluorescent tubes 18. The lamp holders 20 each have light reflectivity and are each configured to block the light from reaching the end portions of the cold cathode fluorescent tubes 18. The inverter board 21 is electrically connected to the cold cathode fluorescent tubes 18 via the connectors 22.

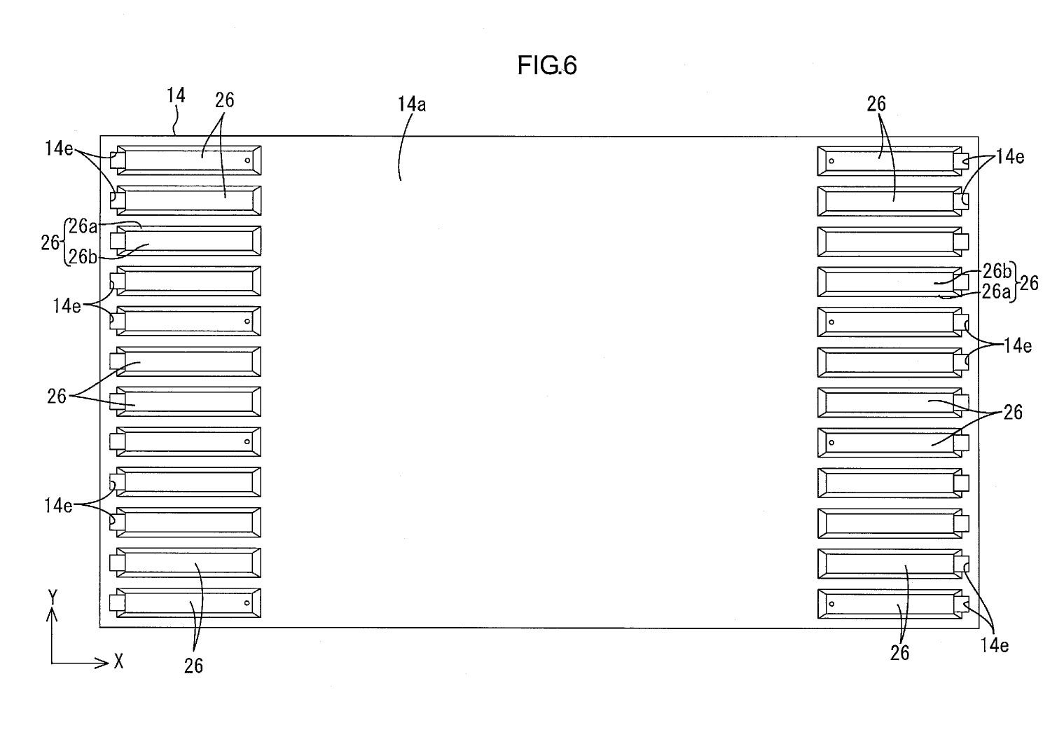

The chassis 14 is made of metal such as aluminum. As illustrated in FIG. 3 and FIG. 4, the chassis 14 includes a bottom plate 14a and a pair of side plates 14c. The bottom plate 14a has a rectangular shape in a plan view (an elongated shape including a long side extending along the X-axis direction) like the liquid crystal panel 11. The side plates 14c each rise from each long side of the bottom plate 14a. The long-side direction of the bottom plate 14a matches the X-axis direction and the short-side direction of the bottom plate 14a matches the Y-axis direction in each drawing. The bottom plate 14a is arranged to face a rear of the cold cathode fluorescent tube 18. In other words, the bottom plate 14a is arranged on a side opposite to the light exit side of the cold cathode fluorescent tube 18. The bottom plate 14a includes clip mounting holes 14d for mounting the lamp clips 19 and connector mounting holes 14e for mounting the connectors 22. The clip mounting holes 14d and the connector mounting holes 14e are arranged at positions corresponding to the lamp clips 19 and the connectors 22, respectively. The reflection sheet 15 is made of a synthetic resin having a white color that provides high light reflectivity. The reflection sheet 15 is arranged to cover a substantially entire of an inner surface of the bottom plate 14a of the chassis 14 and is configured to reflect light emitted from the cold cathode fluorescent tube 18 toward the optical member 16 (the light exit side). Further, the reflection sheet 15 includes through holes communicating with the clip mounting holes 14d at positions overlapping the clip mounting holes 14d in a plan view. The clip mounting holes 14d are not illustrated in FIG. 6.

The optical member 16 has a rectangular shape in a plan view like the bottom plate 14a of the chassis 14 and the liquid crystal panel 11. The optical member 16 is formed of a light transmissive synthetic resin and arranged between the cold cathode fluorescent tubes 18 on the front side and the liquid crystal panel 11 on the rear side. The optical member 16 includes a diffuser plate, a diffuser sheet, a lens sheet, and a luminance increasing sheet in this sequence from the rear side. The optical member 16 is configured to convert the light emitted from the cold cathode fluorescent tubes 18 as the tubular light source into planar light.

The frame 17 has a frame shape extending along an outer edge of the liquid crystal panel 11 and the optical member 16. The frame 17 is arranged on the front side of the optical member 16 such that the outer edge of the optical member 16 is held by the frame 17, a side plate 14c of the chassis 14, and the lamp holder 20, which will be described later. The frame 17 receives a rear surface of the liquid crystal panel 11 such that the liquid crystal panel 11 is sandwiched between the frame 17 and the bezel 13 arranged on the front side of the liquid crystal panel 11.

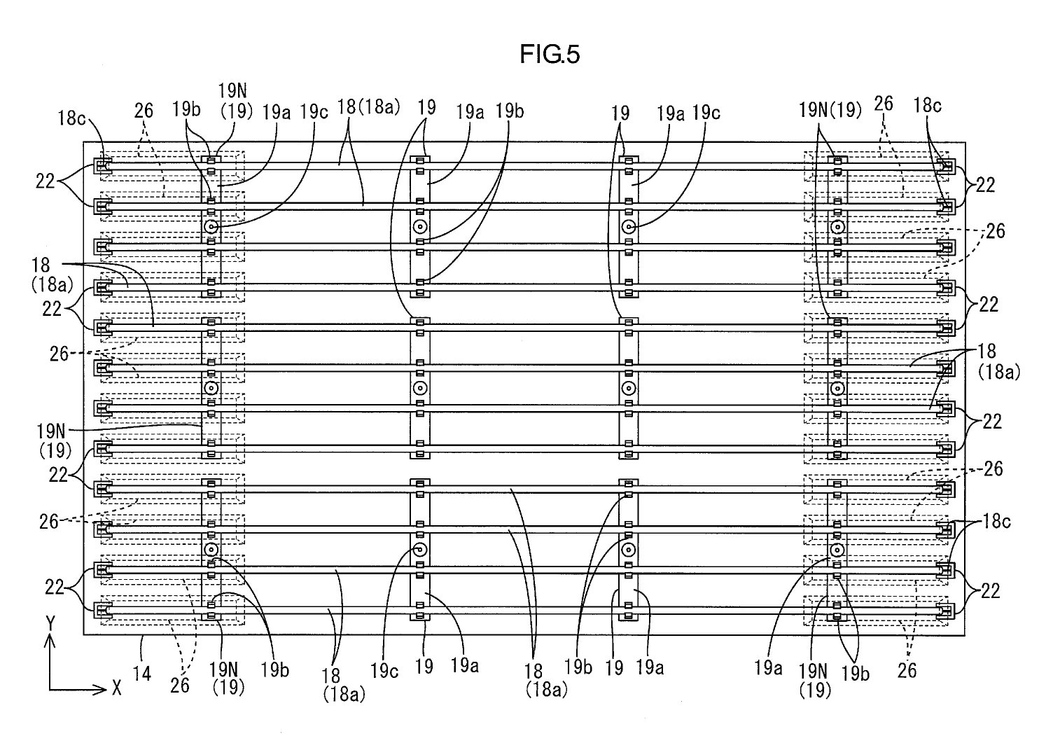

The cold cathode fluorescent tube 18 is a kind of the tubular light source (linear light source). As illustrated in FIG. 5, the cold cathode fluorescent tubes 18 are housed in the chassis 14 such that the axial direction thereof matches the long-side direction (the X-axis direction) of the chassis 14. The cold cathode fluorescent tubes 18 are arranged in the short-side direction (the Y-axis direction) of the chassis 14 such that the axis lines thereof are substantially parallel to each other with a predetermined distance therebetween. The end portions of the cold cathode fluorescent tubes 18 are aligned along the short-side direction of the chassis 14 at the end sections in the long-side direction of the chassis 14. The distances between the cold cathode fluorescent tubes 18 adjacent to each other, i.e., an arrangement pitch, are substantially equal to each other.

The cold cathode fluorescent tube 18 is a kind of discharge tube. As illustrated in FIG. 7, the cold cathode fluorescent tube 18 includes an elongated glass tube 18a having a circular cross-section and closed at both ends, a pair of electrodes sealed inside end portions of the glass tube 18a, and a pair of outer leads (external connecting portions) protruding from the end portions of the glass tube 18a to the outer side. The cold cathode fluorescent tube 18 is a straight-tube type cold cathode fluorescent tube 18 in which the glass tube 18a is linear and the electrodes 18b are each separately arranged at two sides (the right side and the left side in FIG. 3). The glass tube 18a includes mercury that is a light-emitting material inside thereof and a fluorescent material applied on inner surface thereof. The mercury and the fluorescent material are not illustrated in the drawings. The electrodes 18b and the outer leads 18c are formed of conductive metal. Preferably, the electrodes 18b are formed of alloy having high sputtering resistance. The electrodes 18b each have a cup-like shape and are arranged in the end portions of the glass tube 18a. The outer lead 18c has a substantially elongated cylindrical shape. The outer lead 18c extends in the axial direction (the X-axis direction, the longitudinal direction) of the glass tube 18a so as to pass through the end of the glass tube 18a and protrude to the outside. The end of the outer lead 18c positioned inside the glass tube 18a is connected to the electrode 18b in the glass tube 18a to have a potential equal to the electrode 18b.

The lamp clips 19 are each formed of a synthetic resin having a white color that provides high light reflectivity. As illustrated in FIG. 5, the lamp clips 19 are arranged on the bottom plate 14a of the chassis 14 in rows and columns. Specifically, four lamp clips 19 are arranged in the X-axis direction as the row direction so as to be spaced apart from each other and three lamp clips 19 are linearly arranged in the Y-axis direction as the column direction. The lamp clips 19 arranged at ends in the X-axis direction are positioned away from the end portions of the cold cathode fluorescent tube 18 toward the center of the cold cathode fluorescent tube 18. The four lamp clips 19 are arranged in the X-axis direction at substantially regular intervals. Hereinafter, when the lamp clips 19 positioned at the most distal ends in the X-axis direction and the lamp clips 19 positioned therebetween in the X-axis direction are required to be distinguished, the lamp clips 19 positioned at the most distal ends in the X-axis direction, i.e., the lamp clips 19 adjacent to the connectors 22 on an inner side of the chassis 14, will be indicated with a reference sign 19N. However, when the lamp clips 19 positioned at the most distal ends in the X-axis direction and the lamp clips 19 positioned therebetween are not required to be distinguished, they are collectively indicated with the reference sign 19.

The lamp clip 19 includes a main body 19a, lamp gripping portions 19b, a support pin 19c, and mounting portions 19d. The lamp clip 19 extends along the Y-axis direction, i.e., in the direction perpendicular to the axial direction of the cold cathode fluorescent tube 18. The lamp gripping portions 19b protrude from a front surface of the main body 19a toward the cold cathode fluorescent tube 18 and grip the cold cathode fluorescent tube 18. The support pin 19 protrudes from the front surface of the main body 19a and supports the optical member 16 from the rear side. The mounting portions 19d protrude from a rear surface of the main body 19a toward the bottom plate 14a of the chassis 14 and pass through the clip mounting holes 14d. The main body 19a has a portrait rectangular shape in a plan view. The lamp clips 19 are arranged on the bottom plate 14a of the chassis 14 such that the long-side direction of the main body 19a matches the Y-axis direction and the short-side direction thereof matches the X-axis direction. The reflection sheet 15 is sandwiched between the main body 19a and the bottom plate 14a.

As illustrated in FIG. 4, four lamp gripping portions 19b are arranged in the long-side direction (the Y-axis direction) of the main body 19a at intervals therebetween. Each lamp gripping portion 19b grips a different cold cathode fluorescent tube 18. The intervals between the lamp gripping portions 19b adjacent to each other are substantially the same as the intervals between the cold cathode fluorescent tubes 18 arranged in the chassis 14. Each lamp gripping portion 19b includes a pair of arm portions cantilevered from the main body 19a. The glass tube 18a of the cold cathode fluorescent tube 18 is passed through an opening between the arm portions and held by the arm portions. The lamp gripping portion 19b can grip the cold cathode fluorescent tube 18 at the middle portion, i.e., the light emitting portion, which is not the end portion where the electrode 18b is arranged, and thus the positional relation of the cold cathode fluorescent tube 18, the bottom plate 14, and the reflection sheet 15 in the Z-axis direction can be maintained. The support pin 19c is arranged at the middle in the long-side direction of the main body 19a. The support pin 19c has an end-rounded tapered shape. The positional relation between the optical member 16 and the cold cathode fluorescent tube 18 in the Z-axis direction can be maintained by the support pin 19c

The main body 19a is provided with three mounting portions 19d. The mounting portions 19d are arranged between the lamp gripping portions 19b adjacent to each other in the Y-axis direction. The mounting portions 19d are each arranged at the middle of the adjacent lamp gripping portions 19b. The mounting portion 19d positioned at the middle is arranged to overlap the support pin 19c in a plan view. The mounting portions 19d each protrude from the rear surface of the main body 19a. Each mounting portion 19d includes a pair of stoppers extending from the tip end portion thereof toward the main body 19a. The mounting portions 19d are inserted into the corresponding clip mounting holes 14d provided in the bottom plate 14a of the chassis 14. The stoppers are stopped at the outer edges of the clip mounting holes 14d, and thus the lamp clip 19 is mounted to the chassis 14. In such a state, the edge of the clip mounting hole 14d is sandwiched between the main body 19a and the mounting portion 19d.

The lamp holder 20 is formed of a synthetic resin having a white color that provides high light reflectivity. As illustrated in FIG. 2 and FIG. 3, the lamp holder 20 extends along the short-side direction of the chassis 14 and has a box-like shape with an opening on its rear side. The lamp holder 20 is provided along each short side of the chassis 14 such that the end portions of the cold cathode fluorescent tubes 18 and the connector 22 are collectively covered by the lamp holder 20. As illustrated in FIG. 3, the lamp holder 20 includes a stepped section on the front side. The stepped section is an optical member mounting portion 20a on which the optical member 16 is placed. The lamp holder 20 further includes an inclined portion 20b extends from the optical member mounting portion 20a toward the bottom plate 14a of the chassis 14.

The inverter board 21 includes a board formed of a synthetic resin (a phenolic paper or a glass epoxy resin, for example) with a circuit pattern thereon, and electric components such as a transformer is mounted on the invertor board 21. The circuit pattern and the transformer are not illustrated in the drawings. The inverter board 21 is connected to the power P of the liquid crystal display device 10. The inverter board 21 is configured to turn on or off the cold cathode fluorescent tube 18. For example, the inverter board 21 increases voltage inputted from the power P and outputs the increased voltage to the cold cathode fluorescent tube 18. As illustrated in FIG. 3, the inverter board 21 is arranged on a rear surface of the chassis 14, i.e. on a side opposite to the cold cathode fluorescent tube 18. Specifically, the inverter board 21 is provided at each end section in the long-side direction of the bottom plate 14a of the chassis 14 and fixed to the bottom plate 14a by screws. The inverter board 21 includes a connector connecting portion 21a at each end section thereof. The connector connecting portion 21a is fitted into the connector 22.

As illustrated in FIG. 3 and FIG. 5, the connectors are each arranged in the chassis 14 at positions corresponding to the end portions of each of the cold cathode fluorescent tubes 18. In other words, the connectors 22 (in the number corresponding to the number of the cold cathode fluorescent tubes 18) are arranged at end sections in the long-side direction of the bottom plate 14a and aligned in the short-side direction (the Y-axis direction, an arrangement direction of the cold cathode fluorescent tubes 18) of the bottom plate 14a. The arrangement pitch of the connectors 22 is substantially the same as the arrangement pitch of the cold cathode fluorescent tubes 18. The positions of the connectors 22 in the Y-axis direction correspond to the positions of the cold cathode fluorescent tubes 18. The bottom plate 14a of the chassis 14 includes the connector mounting holes 14e at positions where the connectors 22 are mounted, thereby allowing the connectors 22 to be mounted to the chassis 14. The connectors mounting holes 14 (in the number corresponding to the number of the cold cathode fluorescent tubes 18) are aligned in the Y-axis direction.

As illustrated in FIG. 7, the connector 22 includes a housing 23 and a connection terminal 24 housed in the housing 23. The connector 22 is formed of an insulating synthetic resin and has a block-like shape as a whole. The connector 22 is mounted in the chassis 14 so as to pass through the bottom plate 14a of the chassis. The housing 23 includes a light source receiving portion 23a in which the end portion (including the outer lead 18c) of the cold cathode fluorescent tube 18 is arranged and a board receiving portion 23b in which the connector connecting portion 21a of the inverter board 21 is arranged. The light source receiving portion 23a is arranged inside the chassis 14 and the board receiving portion 23b is arranged outside the chassis 14. The light source receiving portion 23a includes a recess to receive the end portion of the cold cathode fluorescent tube 18. The recess has an arc-like shape corresponding to the outer shape of the cold cathode fluorescent tube 18. The board receiving portion 23b includes a board insertion opening 23c opening toward the inverter board 21 in the X-axis direction. Additionally, the housing 23 includes a terminal housing 23d extending from the light source receiving portion 23a to the board receiving portion 23b. The terminal housing 23d houses the connection terminal 24. An end portion of the connection terminal 24 that is arranged in the light source receiving portion 23a is a light source contact portion 24a that elastically contacts and holds the outer lead 18c of the cold cathode fluorescent tube 18. An end portion of the connection terminal 24 that is arranged in the board receiving portion 23b is a board contact portion 24b that elastically contacts with the connector connection 21a of the inverter board 21. The output voltage from the inverter board 21 can be inputted to the outer lead 18c and the electrode 18b of the cold cathode fluorescent tube 18 through the connection terminal 24 of the connector 22.

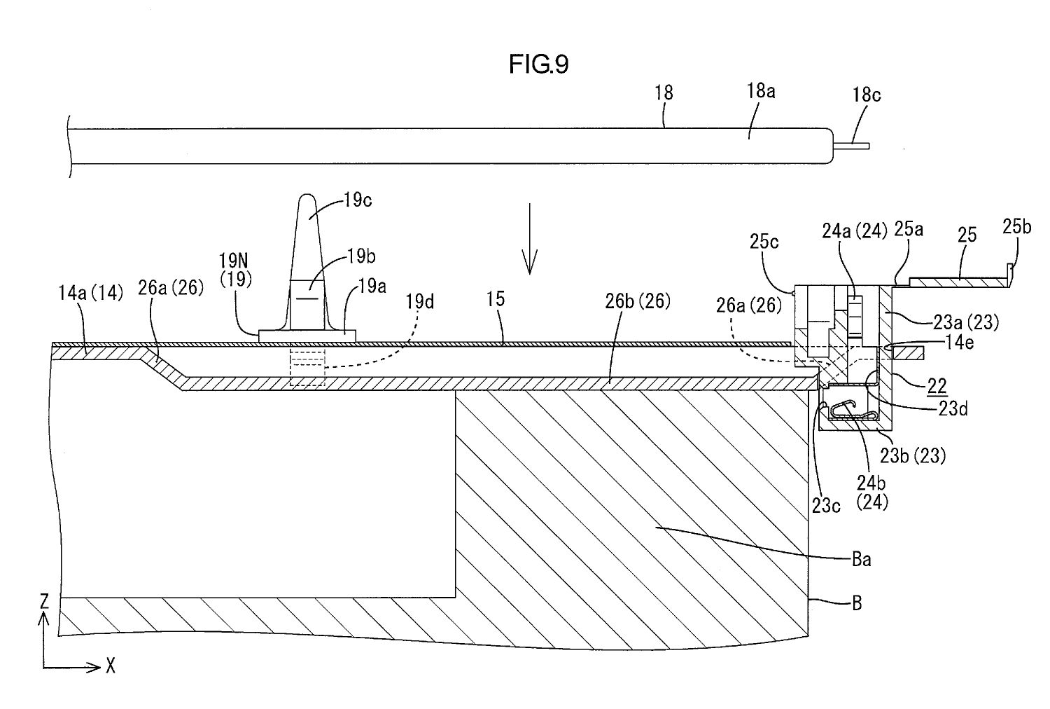

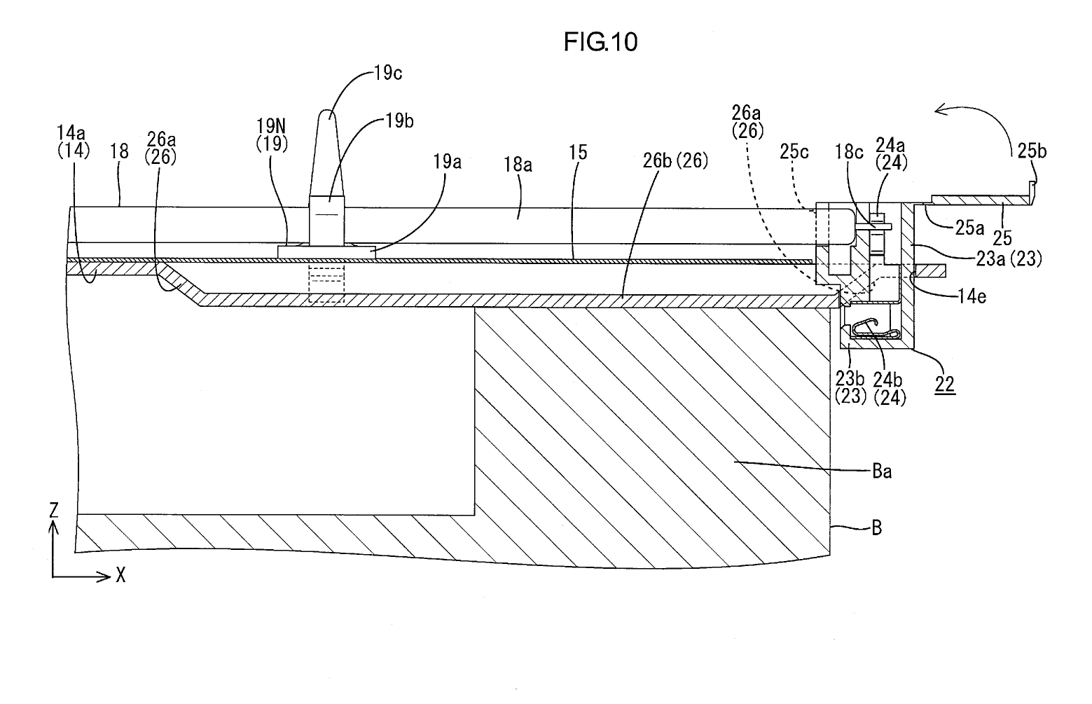

The housing 23 is integrally provided with a lid 25 that can open and close the light source receiving portion 23a having an opening on the front side. The lid 25 has a size enough to cover the opening of the light source receiving portion 23a. An end portion of the lid 25 on the side close to the end of the chassis 14 is integrally connected to the housing 23 via a hinge 25a. The other end portion of the lid 25 on the side close to the middle section of the chassis 14 is not connected to the housing 23. The lid 25 can turn on the hinge 25a with respect to the housing 23. The lid 25 may be selectively positioned at one of an opened position (FIG. 9 and FIG. 10) in which the light source receiving portion 23a is opened and a closed position (FIG. 7) in which the light source receiving portion 23 is closed. The lid 24 at the closed position faces the end portion of the cold cathode fluorescent tube 18 housed in the light source receiving portion 23a, and thus the cold cathode fluorescent tube 18 does not drop off. In addition, the lid 25 includes a lock piece 25b on the end portion on the side opposite to the hinge 25a and the light source receiving portion 23a includes a lock protrusion 25c on an outer surface thereof. The lock piece 25b is fitted with the lock protrusion 25c to hold the lid 25 in the closed position.

The chassis 14 according to the present embodiment includes the reinforcing portion 26 to reinforce the chassis 14. As illustrated in FIG. 3 and FIG. 4, the reinforcing portion 26 is integrally formed with the bottom plate 14a of the chassis 14. In the production of the chassis 14, a part of the bottom plate 14a is subjected to a drawing process, for example, to have the reinforcing portion 26 having a desired shape. The reinforcing portion 26 is formed by partially protruding the bottom plate 14a toward the rear side, i.e., the side opposite to the cold cathode fluorescent tube 18. The reinforcing portion 26 includes a peripheral wall 26a rising from the rear surface of the bottom plate 14a and a bottom wall 26b extending from an end of the peripheral wall 26a. The reinforcing portion 26 has a substantially landscape truncated pyramid shape in which the width of the reinforcing portion 26 decreases toward the side opposite to the cold cathode fluorescent tube 18. Thus, the reinforcing portion 26 has a substantially trapezoidal cross-section taken along the Z-axis direction. The peripheral wall 26a is inclined with respect to the bottom plate 14a. The main plate surface of the above-described inverter board 21 is attached to the bottom wall 26b of the reinforcing portion 26 and the inverter board 21 is fixed thereto with screws. In other words, the reinforcing portion 26 is also configured to fix the inverter board 21 and position the inverter board 21 with respect to the board insertion opening 23c.

As illustrated in FIG. 5 and FIG. 6, the reinforcing portion 26 having a shape elongated in the X-axis direction in a plan view is arranged on the bottom plate 14a of the chassis 14 at positions close to each end in the long-side direction of the bottom plate 14a (the X-axis direction). The reinforcing portions 26 are arranged in the Y-axis direction on the positions close to each end in the long-side direction of the bottom plate 14a such that the long-side direction thereof matches the X-axis direction. Each of the reinforcing portions 26 is arranged to overlap each of the cold cathode fluorescent tubes 18 in a plan view. Specifically, each reinforcing portion 26 overlaps the cold cathode fluorescent tube 18 over the substantially entire length and the entire width in a plan view. The reinforcing portion 26 is arranged such that the middle thereof in the Y-axis direction matches the middle of the cold cathode fluorescent tube 18 in the Y-axis direction. The width of the reinforcing portion 26 is larger than the diameter of the cold cathode fluorescent tube 18. The clip mounting holes 14d are arranged so as not to overlap the reinforcing portions 26, i.e., between the reinforcing portions 26 adjacent to each other in the Y-axis direction. The reinforcing portion 26 is arranged on each end section of the bottom plate 14a in the long-side direction such that the reinforcing portion 26 corresponds to each end portion of the cold cathode fluorescent tube 18 and each connector 22 holding the end portion of the cold cathode fluorescent tube 18.

As illustrated in FIG. 5 and FIG. 7, the reinforcing portion 26 extends from the connectors 22 positioned on the end section of the bottom plate 14a of the chassis 14 to the lamp clips 19N adjacent to the connectors 22. That is, a formation area of the reinforcing portion 26 extends from the connector 22 to the lamp clips 19N adjacent to the connectors 22. Specifically, the reinforcing portion 26 extends in the long-side direction thereof (the X-axis direction) from substantially the center of the connector beyond the lamp clip 19N adjacent to the connector 22. The end of the reinforcing portion 26 on the end section of the chassis 14 is positioned near the center of the connector mounting hole 14e in the X-axis direction. The reinforcing portion 26 is arranged to overlap both of the connector 22 and the lamp clip 19N adjacent to the connector 22 in a plan view. Specifically, the reinforcing portion 26 overlaps a part of the connector 22 in the X-axis direction, particularly, a little more than half an area of the connector 22 in a plan view. Further, the reinforcing portion 26 overlaps the entire width of the lamp clip 19N measured in the X-axis direction in a plan view.

The present embodiment has the above-described structure, and an operation thereof will be described. The liquid crystal panel 11, the backlight unit 12, and the bezel 13, for example, are separately produced and assembled into the liquid crystal display device 10. Then, a production procedure of the backlight unit 12 will be described in detail.

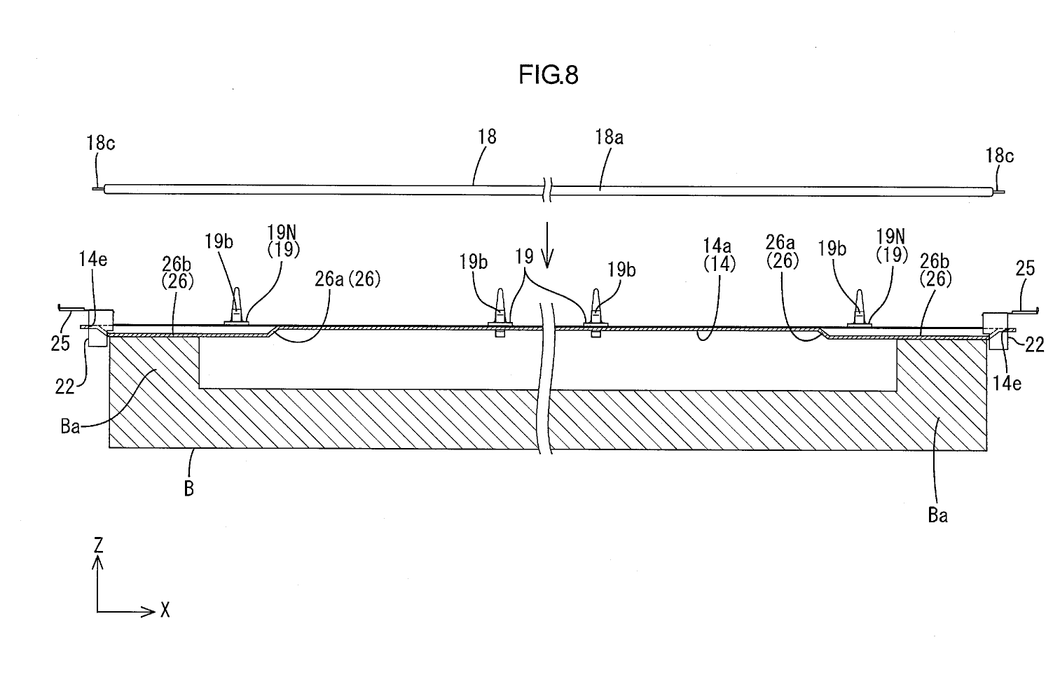

As illustrated in FIG. 8, the chassis 14 is placed on a work table B to assemble the backlight unit 12. The work table B includes a pair of supporting members Ba each supporting each end section in the long-side direction of the chassis 14. The chassis 14 placed on the work table B is supported by the supporting members Ba at the bottom wall 26b of each reinforcing portion 26 integrally formed with the bottom plate 14a of the chassis 14 and protruding from the rear surface of the bottom wall 26b. In this state, only a portion of the bottom wall 26b positioned on the end section of the chassis 14 is placed on the supporting member 26b. The connectors 22 are attached to corresponding connector mounting holes 14e of the bottom plate 14a. The lid 25 of the connector 22 remains open at this stage. The reflection sheet 15 is arranged to cover an inner surface of the bottom plate 14a. Then, the lamp clips 19 are attached to corresponding positions of the bottom plate 14a. The mounting portions 19d are inserted into the lamp clip mounting holes 14d such that the stoppers included in the mounting portions 19d are stopped by the edge of the clip mounting holes 14d. Thus, the lamp clips 19 is mounted to the chassis 14 while the bottom plate 14a and the reflection sheet 1 are sandwiched between the main body 19a and the mounting portions 19d (FIG. 4).

Next, the cold cathode fluorescent tubes 18 are mounted. Starting from the state illustrated in FIG. 8 and FIG. 9, the end portions of the cold cathode fluorescent tube 18 are positioned to correspond to the connectors 22 and then housed in the chassis 14. As a result, as illustrated in FIG. 10, each end portion of the cold cathode fluorescent tube 18 is fitted in the light source receiving portion 23 of each connector 22 and the middle portion of the cold cathode fluorescent tube 18 is gripped by the lamp gripping portion 19b of each lamp clip 19. At this time, each outer lead 18c of the cold cathode fluorescent tube 18 is in an electrically conductive contact with the light source contact portion 24a of the connection terminal 24 included in each connector 22 and elastically held by the light source contact portion 24a. With this configuration, each cold cathode fluorescent tube 18 is held by the connectors 22 at the end portions thereof and held by the lamp clips 19 at the middle portions thereof.

After the cold cathode fluorescent tubes 18 are housed in the chassis 14, the lid 25 of the connector 22 is closed. The lid 25 is turned around the hinge 25a in the direction indicated by an arrow from the state in FIG. 10 such that the lid 25 is positioned on the opening of the light source receiving portion 23a of the housing 23. Then, as illustrated in FIG. 7, the lid 25 is positioned to face the front side of the end portion of the cold cathode fluorescent tube 18 housed in the light source receiving portion 23a. In addition, the locking piece 25b is fitted in the locking protrusion 25c. Thus, the lid 25 is held in a position, and the cold cathode fluorescent tube 18 does not drop off.

At the time of closing the lid 25, a large force may act on the end section of the chassis 14 in the long-side direction via the connector 22. This may cause displacement of the end section of the chassis 14 in the long-side direction toward the middle section of the chassis 14, and thus the chassis 14 may be deformed. In such a case, the cold cathode fluorescent tube 18 cannot be deformed flexibly with the deformation of the chassis 14, because the end portions and the middle portions of the cold cathode fluorescent tube 18 are held (gripped) by the connectors 22 and the lamp clips 19, respectively. This may result in stress concentration in the middle portions of the cold cathode fluorescent tube 18 held by the lamp clips 19N adjacent to the connector 22, and thus the glass tube 18a may be damaged or broken. However, in the present embodiment, the reinforcing portion 26 integrally formed with the bottom plate 14a of the chassis 14 extends from the connector 22 to the lamp clip 19N adjacent to the connector 22. Accordingly, the deformation is less likely to occur in the bottom plate 14a over the area from the connectors 22 to the lamp clips 19N even if the force described above acts on the chassis 14. Further, the reinforcing portion 26 according to the present embodiment extends beyond the lamp clip 19N adjacent to the connector 22 to the inner side of the chassis 14. Accordingly, the deformation is less likely to occur in the chassis 14 around the lamp clip 19N. This particularly can reduce the stress concentration that may act on the portion of the cold cathode fluorescent tube 18 held by the lamp clip 19N adjacent to the connector 22, and thus the cold cathode fluorescent tube 18 is less likely to be damaged or broken at the portion held by the lamp clip 19N.

After the mounting of the cold cathode fluorescent tubes 18 and the closing the lid 25, the lamp holder 20 is attached to each end section of the chassis 14 in the long-side direction. Then, the connectors 22 aligned in the Y-axis direction and the end portions of the cold cathode fluorescent tubes 18 are housed in the lamp holder 20. Subsequently, the optical member 16 is provided to cover the opening 14b of the chassis 14 such that an outer peripheral portion of the optical member 16 is placed on the optical member mounting portion 20a of the lamp holder 20. At the time of mounting the lamp holder 20 and the optical member 16 in this way, a large stress may act on the end sections of the chassis 14 in the long-side direction. However, in the present embodiment, the chassis 14 is reinforced by the reinforcing portions 26 as above, and thus the chassis 14 is less likely to be deformed. Accordingly, the cold cathode fluorescent tube 18 is less likely to be damaged due to the deformation of the chassis 14.

The inverter board 21 is mounted to the rear surface of the chassis 14, while the lamp holders 20 and the optical member 16 are mounted. A rear plate surface of the inverter board 21 is attached to the bottom wall 26b of the reinforcing portions 26, and thus the connector connecting portion 21a can be positioned in the Z-axis direction with respect to the board insertion opening of the board receiving portion 24b of the connector 22. The connector connecting portion 21a in such a state is inserted into the board insertion opening 23c such that a terminal of the connector connecting portion 21a elastically contacts with the board contact portion 24b of the connection terminal 24. As a result, the inverter board 21 is elastically connected with the cold cathode fluorescent tube 18 via the connector 22. The inverter board 21 is fixed to the reinforcing portions 26 with screws. The backlight unit 12 is assembled as described above. The liquid crystal panel 11, the bezel 13, and the like are mounted to the backlight unit 12 to obtain the liquid crystal display device 10 (FIG. 3).

As described above, the backlight unit (the lighting device) 12 according to the present embodiment includes the cold cathode fluorescent tubes (the tubular light source) 18 each including the outer lead (the external connecting portion) 18c at the end portion thereof, the chassis 14 housing the cold cathode fluorescent tube 18, the connector 22 attached to the end section of the chassis and electrically connected to the outer lead 18c, the lamp clip (the light source holder) 19 mounted on the middle section of the chassis 14, and the reinforcing portion 26 provided on at least an area extending from the connector 22 to the lamp clip 19N adjacent to the connector 22. The connector 22 holds the end portion of the cold cathode fluorescent tube 18. The lamp clip 19N holds the middle portion of the tubular light source 18.

In this configuration, the end portion of the cold cathode fluorescent tube 18 including the outer lead 18c is held by the connector 22 and the middle portion of the cold cathode fluorescent tube 18 is held by the lamp clip 19. If force acts on the chassis 14 and the end section on which the connector 22 is arranged and the middle section on which the lamp clip 19 are displaced, the chassis 14 may be deformed. In such a case, the deformation of the cold cathode fluorescent tube 18 with the deformation of the chassis 14 may be restricted, because the end portion and the middle portion of the cold cathode fluorescent tube 18 are held by the connector 22 and the lamp clip 19, respectively. This may result in a stress concentration particularly on a portion of the tubular light source 18 held by the lamp clip 19N, and the portion may be damaged.

However, according to the present embodiment, the reinforcing portion 26 is arranged to extend at least from the connector 22 to the lamp clip 19N adjacent to the connector 22. With this configuration, if the force described above acts on the chassis 14, the deformation is less likely to occur in an area of the chassis 14 between the connector 22 and the lamp clip 19N adjacent to the connector 22. This can reduce the stress concentration on the portion of the cold cathode fluorescent tube 18 held by the lamp clip 19N adjacent to the connector 22, and thus the cold cathode fluorescent tube 18 is less likely to be damaged.

The chassis 14 integrally includes the reinforcing portion 26 by protruding the part of the chassis 14. With this configuration, the reinforcing portion 26 can be integrally formed with the chassis 14. Compared with a case that the reinforcing portion 26 is a separate member from the chassis 14, the chassis 14 can be properly reinforced and the cost can be reduced.

The reinforcing portion 26 protrudes toward the side opposite to the cold cathode fluorescent tube 18. With this configuration, in the assembling operation of the backlight unit 12, the reinforcing portion 26 protruding toward the side opposite to the cold cathode fluorescent tube 18 can be placed on the work table B, for example. Thus, the work table B can receive the force acts on the chassis 14 during the assembling operation through the reinforcing portion 25.

The reinforcing portion 26 has an elongated shape, and the long-side direction of the reinforcing portion 26 matches the axial direction of the cold cathode fluorescent tube 18. With this configuration, the chassis 14 can be properly reinforced, and thus the cold cathode fluorescent tube 18 is less likely to be damaged.

The reinforcing portion 26 overlaps at least apart of the cold cathode fluorescent tube 18 in a plan view. With this configuration, the chassis 14 can be effectively reinforced and the cold cathode fluorescent tube 18 is less likely to be damaged compared with the case that the reinforcing portion 26 does not overlap the cold cathode fluorescent tube 18 in a plan view. Further, if parasitic capacitance exits between the cold cathode fluorescent tube 18 and the chassis 14, the parasitic capacitance is less likely to change because the deformation of the portion of the chassis 14 overlapping the part of the cold cathode fluorescent tube 18 is reduced by the reinforcing portion 26. Thus, the brightness of the cold cathode fluorescent tube 18 can be stabilized.

The reinforcing portion 26 has the width that is larger than the diameter of the cold cathode fluorescent tube 18. With this configuration, the chassis 14 is further less likely to be deformed, and the cold cathode fluorescent tube 18 is further less likely to be damaged.

The reinforcing portion 26 overlaps at least apart of the lamp clip 19N adjacent to the connector 22 in a plan view. With this configuration of the reinforcing portion 26, the part of the chassis 14 around the lamp clip 19N is less likely to be deformed, and thus the part of the cold cathode fluorescent tube 18 held by the lamp clip 19N is less likely to be damaged.

The reinforcing portion 26 overlaps at least apart of the connector 22 in a plan view. With this configuration of the reinforcing portion 26, the part of the chassis 14 around the connector 22 is less likely to be deformed, and thus the portion of the cold cathode fluorescent tube 18 held by the connector 22 is less likely to be damaged.

The reinforcing portion 26 at least extends from the connector 22 beyond the lamp clip 19N adjacent to the connector 22. With this configuration of the reinforcing portion 26, the portion of the chassis 14 around the lamp clip 19N is less likely to be deformed, and thus the portion of the cold cathode fluorescent tube 18 held by the lamp clip 19N is less likely to be damaged.

The connector 22 includes the housing 23 and the connection terminal 24. The housing 23 includes the light source receiving portion 23a configured to receive the cold cathode fluorescent tube 18. The connection terminal 24 is arranged in the housing 23 and is in contact with the outer lead 18c. With this configuration, when the end portion of the cold cathode fluorescent tube 18 is housed in the light source receiving portion 23a of the housing, the outer lead 18c comes in contact with the outer lead 18c.

The light source receiving portion 23a has the opening and the connector 22 includes the lid 25 closing the opening. With this configuration, by closing the light source receiving portion 23a with the lid 25 after the end portion of the cold cathode fluorescent tube 18 is housed in the light source receiving portion 23a, the cold cathode fluorescent tube 18 is less likely to drop off. A large force may act on the end section of the chassis 14 where the connector 22 is arranged when the light source receiving portion 23a is closed with the lid 25. However, in this configuration, even if the large force acts on the end section, the portion of the chassis 14 where the reinforcing portion 26 is arranged is less likely to be deformed, and thus the cold cathode fluorescent tube 18 is less likely to be damaged.

The lid 25 is integrally formed with the housing 23. With this configuration, the number of components can be reduced compared with the case that the lid 25 and the housing 23 are separate members. This facilitates parts management, for example.

The backlight unit 12 further include the inverter board (the power supply board) 21 electrically connected to the connector 22 so as to supply power to the cold cathode fluorescent tube 18. The inverter board 21 has the plate surface that is attached to the reinforcing portion 26. With this configuration, the chassis 14 is secondarily reinforced by the inverter board 21, and thus the cold cathode fluorescent tube 18 is less likely to be damaged.

The inverter board 21 is fixed on the reinforcing portion 26. With this configuration, the inverter board 21 can be fixed through the reinforcing portion 26.

The cold cathode fluorescent tube 18 includes a plurality of cold cathode fluorescent tubes 18. The cold cathode fluorescent tubes 18 are arranged in the chassis 14 such that the axes thereof are arranged parallel to each other. The lamp clip 19 includes the main body 19a and a plurality of lamp gripping portions (the light source gripping portions) 19b. The main body 19a extends in the direction intersecting with the axis of each of the cold cathode fluorescent tubes 18. The lamp gripping portions 19b protrude from the main body 19a toward the cold cathode fluorescent tubes 18 and grip the cold cathode fluorescent tubes 18. With this configuration, each lamp source gripping portion 19b of the lamp clips 19 can grip each cold cathode fluorescent tube 18, and thus each cold cathode fluorescent tube 18 can be held.

The reinforcing portion 26 includes a plurality of reinforcing portions 26. The reinforcing portions 26 are arranged to correspond to the cold cathode fluorescent tubes 18 and each extend along the axial direction of the cold cathode fluorescent tubes 18. The chassis 14 includes the clip mounting hole (the mounting hole) 14d between the reinforcing portions 26 adjacent to each other. The main body 19a of the lamp clip 19 is provided with the mounting portion 19d. The mounting portion 19d is inserted into the clip mounting hole 14d such that the edge of the clip mounting hole 14d is sandwiched between the main body 19a and the mounting portion 19d. In this configuration, when the mounting portion 19d is inserted into the clip mounting hole 14d between the reinforcing portions 26 adjacent to each other, the edge of the clip mounting hole 14d can be sandwiched between the main body 19a and the mounting portion 19d, and thus the lamp clip 19 can be attached to the chassis 14.

The backlight unit 12 further include the lamp holder (the cover member) 20 attached to the chassis 14. The lamp holder 20 covers the connector 22 and the end portion of the cold cathode fluorescent tube 18. With this configuration, the lamp holder 20 can cover the connector 22 and the end portion of the cold cathode fluorescent tube 18, and thus the connector 22 and the end portion are less likely to be recognized as dark portions. At the time of mounting the lamp holder 20 on the chassis 14A, a large force may act on the end section of the chassis 14 where the connector 22 is arranged. However, in this configuration, even if the large force acts on the end section, the portion of the chassis 14 where the reinforcing portion 26 is arranged is less likely to be deformed, and thus the cold cathode fluorescent tube 18 is less likely to be damaged.

The cold cathode fluorescent tubes 18 are arranged in the chassis 14 such that axes thereof are arranged parallel to each other. The connectors 22 are arranged at the positions corresponding to the end portions of the cold cathode fluorescent tubes 18. The lamp holder 20 is arranged to extend along the direction intersecting with the axis of each of the cold cathode fluorescent tubes 18 and collectively cover the connectors 22 and the end portions of the cold cathode fluorescent tubes 18. With this configuration, the connectors 22 and the end portions of the cold cathode fluorescent tubes 18 can be covered with the lamp holder 20 arranged to extend along the direction intersecting with the axes of the cold cathode fluorescent tubes 18. This facilitates the assembling operation of the backlight unit 12.

The tubular light source is the cold cathode fluorescent tube 18. With this configuration, a service life of the light source can be longer and control of light can be easily performed.

### Second Embodiment

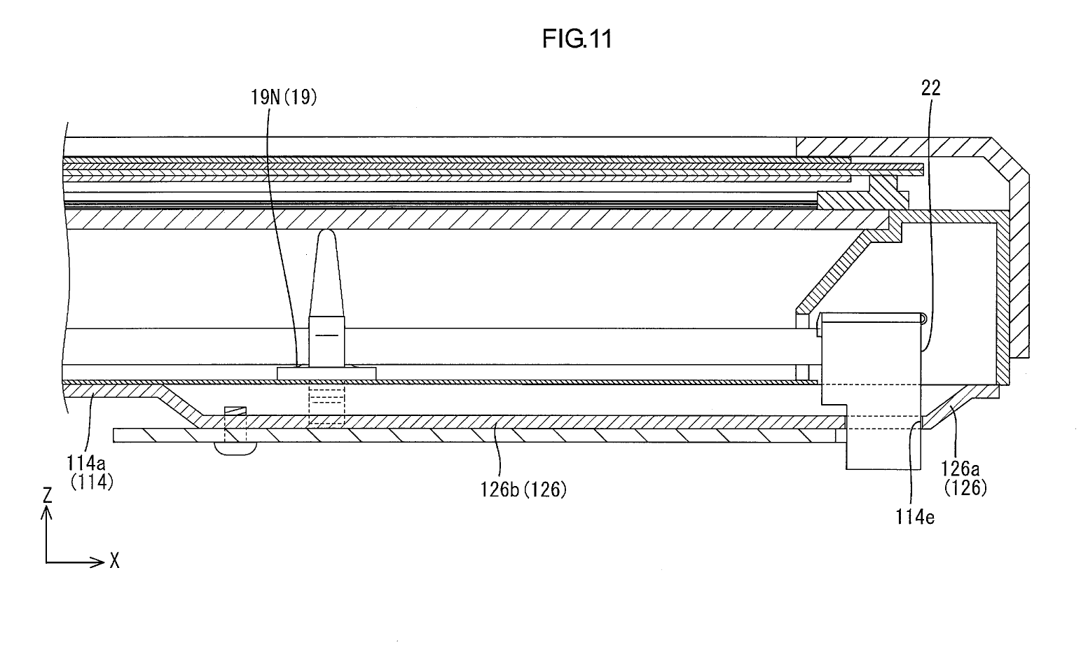

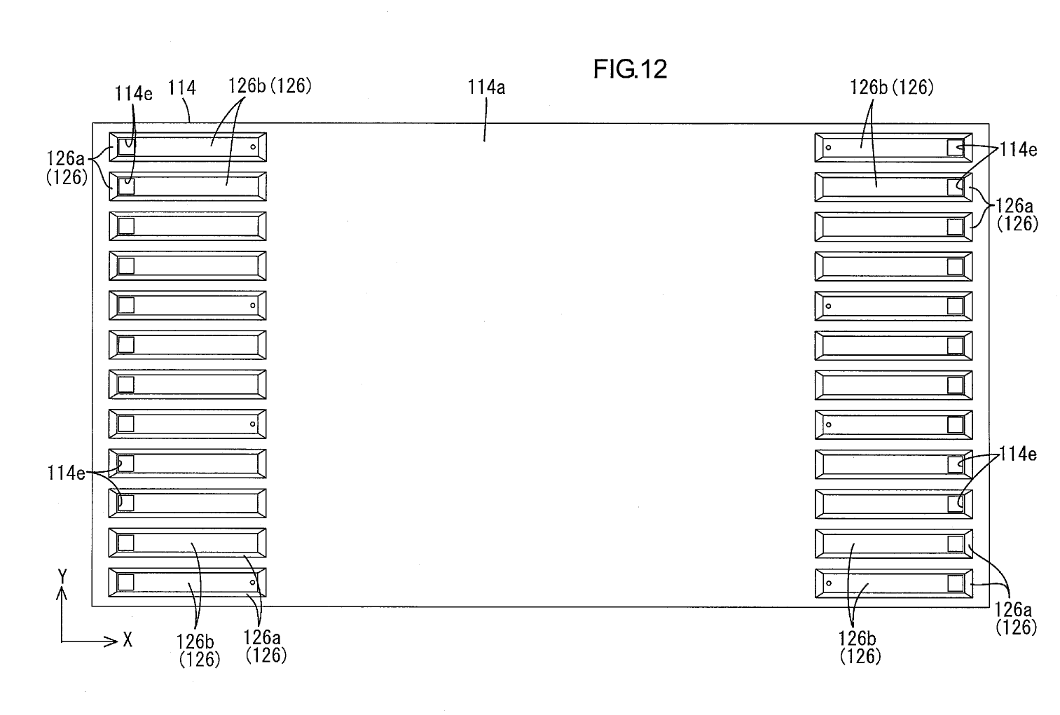

The second embodiment of the present invention will be explained with reference to FIG. 11 and FIG. 12. The formation area of a reinforcing portion 126 is changed. The construction, operations and effects same as those in the first embodiment will not be explained.

As illustrated in FIG. 11 and FIG. 12, the reinforcing portion 126 of the present embodiment extends from the position closer to the end of the bottom plate 114a than the connector 22 beyond the lamp clip 19N adjacent to the connector 22. In other words, in addition to the area including the connector 22 and the lamp clip 19N adjacent to the connector 22, the formation area of the reinforcing portion 126 includes an area extended therefrom. In this configuration, a connector mounting hole 114e to which the connector 22 is attached is formed in a bottom wall 126b of the reinforcing portion 126. Further, a part of the peripheral wall 126a of the reinforcing portion 126 surrounds the connector 22. With this configuration, a chassis 314 can be more efficiently reinforced.

As describe above, according to this embodiment, the reinforcing portion 126 is provided on at least an area extending from the position close to the end of the chassis 114 than the connector 22 to the lamp clip 19N adjacent to the connector 22. With this configuration, deformation is less likely to occur in an area of the chassis 114 around the connector 22, and thus the portion of the cold cathode fluorescent tube 18 held by the connector 22 is less likely to be damaged.

### Third Embodiment

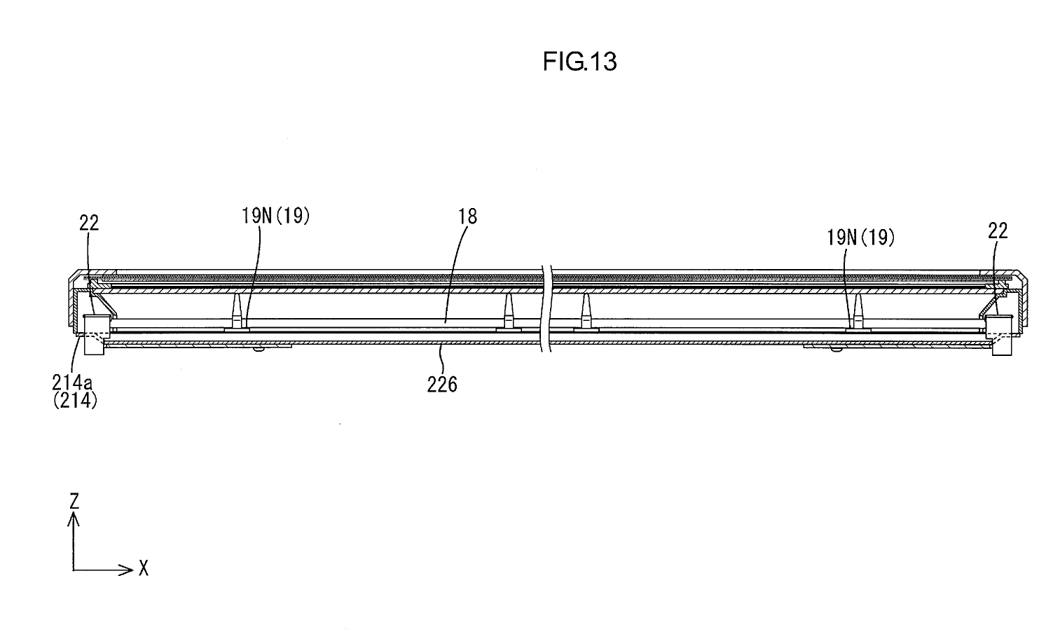

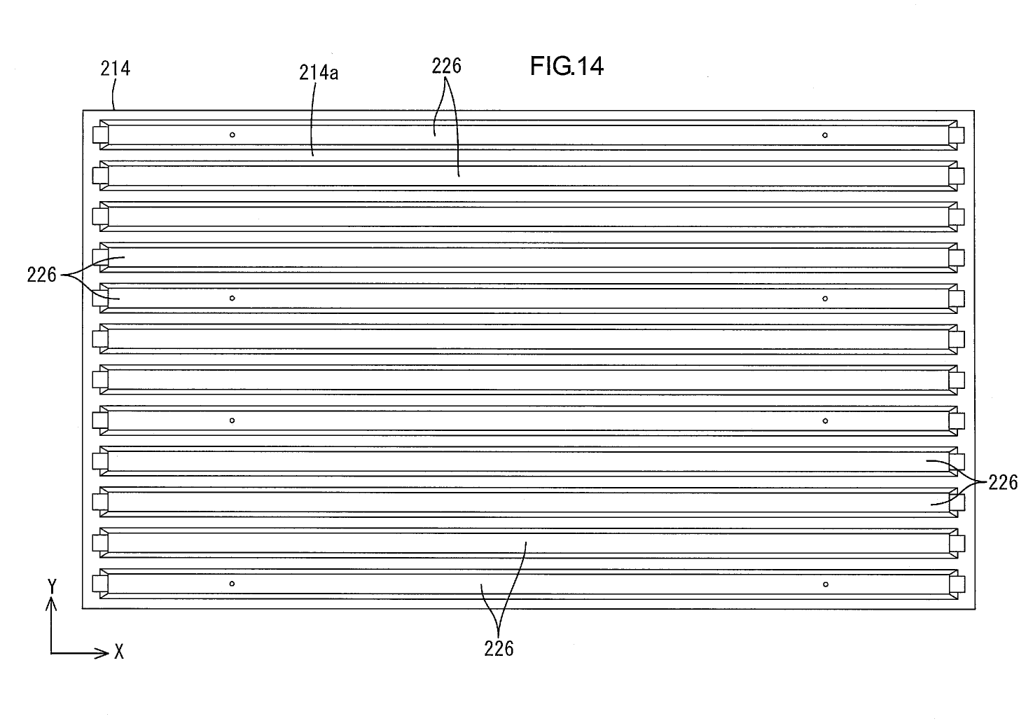

The third embodiment of the present invention will be explained with reference to FIG. 13 and FIG. 14. The formation area of a reinforcing portion 226 is changed in this third embodiment. The construction, operations and effects same as those in the first embodiment will not be explained.

As illustrated in FIG. 13 and FIG. 14, the reinforcing portion 226 extends over substantially the entire length in the long-side direction of a bottom plate 214a of a chassis 214. Specifically, the connector 22 is mounted to each end section of the chassis 14 in the long-side direction so as to correspond to the end portions of the cold cathode fluorescent tube 18, and the reinforcing portion 226 extends from the connector 22 on one of the end sections to the connector 22 on the other one of the end sections. In other words, in addition to the area between the connector 22 and the lamp clip 19N, the formation area of the reinforcing portion 226 includes an area between two lamp clips 19N adjacent to each connector 22, i.e., an area extended from the area between the connector 22 and the lamp clip 19N. Namely, the formation area of the reinforcing portion 226 extends over the entire length of the cold cathode fluorescent tube 18, and the reinforcing portion 226 overlaps substantially the entire area of the cold cathode fluorescent tube 18 in a plan view. With this configuration, the chassis 314 can be further effectively reinforced.

As described above, according to the present embodiment, the cold cathode fluorescent tube 18 includes the outer lead 18c at each end portion thereof, and the connector 22 is mounted to the chassis 214 so as to correspond to each outer lead 18c and the reinforcing portion 226 is arranged to extend over the area between one of the connectors 22 to the other one of the connectors 22. With this configuration, the deformation is less likely to occur in the area between the connectors 22, i.e., the area over substantially the entire length of the cold cathode fluorescent tube 18 due to the reinforcing portion 226. Thus, the cold cathode fluorescent tube 18 is less likely to be damaged over substantially the entire length thereof.

### Fourth Embodiment

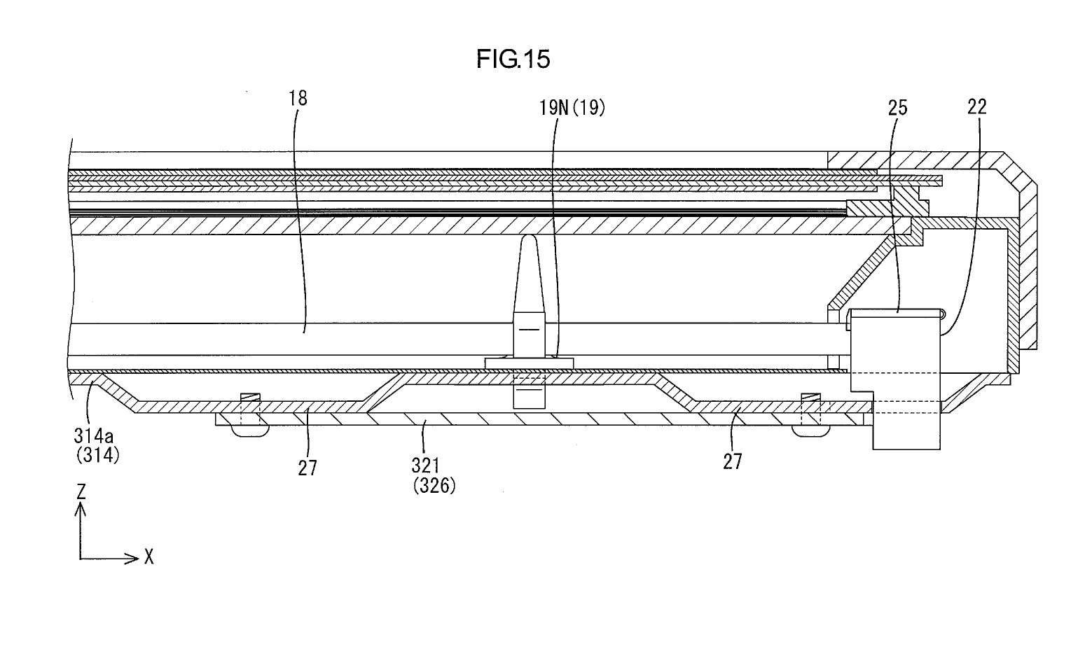

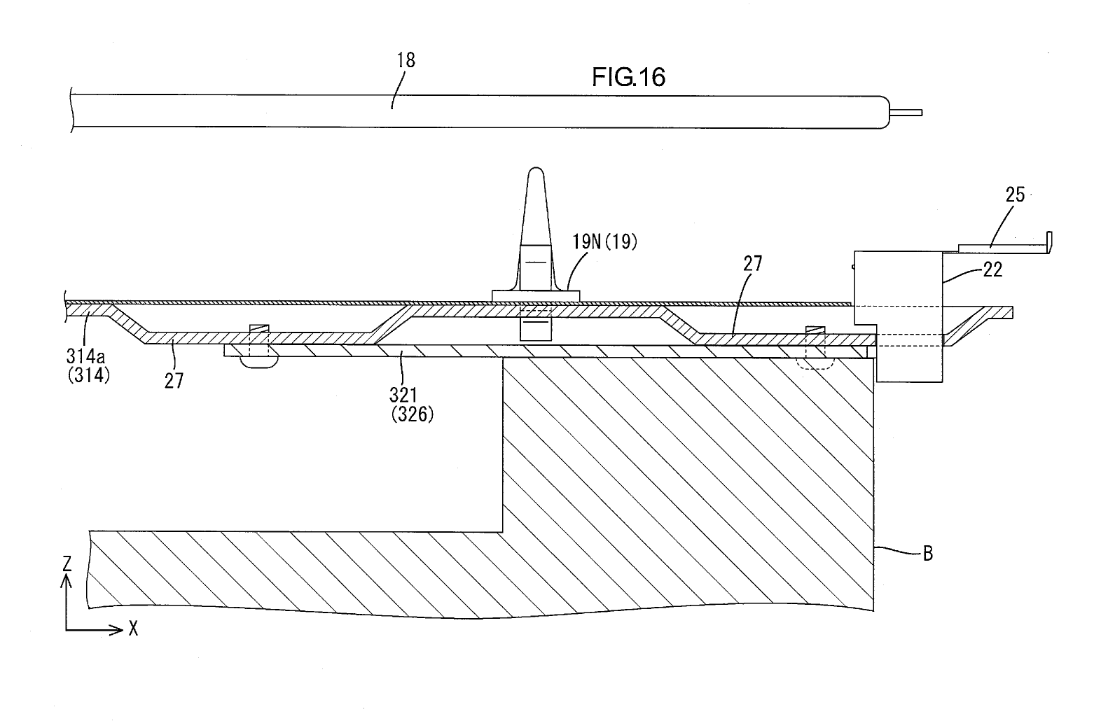

The fourth embodiment of the present invention will be explained with reference to FIG. 15 and FIG. 16. In this fourth embodiment, an inverter board 321 is used as a reinforcing portion 326. The construction, operations and effects same as those in the first embodiment will not be explained.

As illustrated in FIG. 15, a pair of ribs 27 each protruding from the rear surface of the chassis 14 is provided on a side close to the end of the bottom plate 314a of the chassis 314 in the long-side direction. The ribs 27 are arranged in the long-side direction of the chassis 14 with the lamp clip 19N located therebetween. Like the reinforcing portion 26 described in the first embodiment, the bottom plate 14a is subjected to a drawing process to integrally include the ribs 27. The ribs 27 protrude from the bottom plate 14a to substantially the same height. The inverter board 321 is arranged to connect the pair of ribs 27 and a front surface of the inverter board 321 is in contact with the ribs 27. The inverter board 321 is fixed to the ribs 27 with screws. Accordingly, the inverter board 321 is arranged to extend from the connector 22 beyond the lamp clip 19N adjacent to the connector 22 with the ribs 27 being located between the bottom plate 14a and the inverter board 321. The inverter board 321 can function as the reinforcing portion 326.

As illustrated in FIG. 16, before the cold cathode fluorescent tube 18 is attached to the chassis 314, the inverter board 321 is attached to the rear surface of the chassis 314. The inverter board 321 attached to the chassis 314 is mounted on the work table B, and then, the cold cathode fluorescent tube 18 is attached and the lid 25 is closed. With this configuration, when large force acts on the end section of the chassis 314 in the long-side direction at the time of closing the lid 25, the inverter board 321 functions as the reinforcing portion 326 of the chassis 314. Thus, the bottom plate 314a of the chassis 314 is less likely to be deformed, and the cold cathode fluorescent tube 18 is less likely to be damaged or broken.

### Other Embodiments

The present invention is not limited to the above embodiments described in the above description and the drawings. The following embodiments are also included in the technical scope of the present invention, for example.

(1) The formation area of the reinforcing portion in the long-side direction may be suitably changed from that of the above embodiments. For example, the reinforcing portion may extend from the connector to a front of the lamp clip adjacent to the connector (without extending beyond the lamp clip).

(2) The formation area of the reinforcing portion in the width direction may be suitably changed like the above (1). For example, the width of the reinforcing portion may be substantially the same as the diameter of the cold cathode fluorescent tube, or may be smaller than the diameter of the cold cathode fluorescent tube.

(3) In the above embodiments, the reinforcing portion is provided separately for each cold cathode fluorescent tube. However, the reinforcing portion may have such a width as to extend over two or more cold cathode fluorescent tubes. In such a case, the long-side direction of the reinforcing portion may match the Y-axis direction, i.e., the direction perpendicular to the axial direction of the cold cathode fluorescent tube.

(4) In the above embodiments, everyone of the cold cathode fluorescent tubes provided in the chassis includes the reinforcing portion. However, not everyone of the cold cathode fluorescent tubes may include the reinforcing portion. The number of reinforcing portions may be less than the number of the cold cathode fluorescent tubes.

(5) In the above embodiments, the reinforcing portion is arranged such that the middle thereof in the Y-axis direction matches the axis of the cold cathode fluorescent tube. However, the middle of the reinforcing portion in the Y-axis direction may not match the axis of the cold cathode fluorescent tube.

(6) In the above embodiments, the reinforcing portions overlap the cold cathode fluorescent tubes in a plan view. However, according to the present invention, the reinforcing portions may not overlap the cold cathode fluorescent tube in a plan view.

(7) In the above embodiments, the inverter board is attached and fixed to the reinforcing portion. However, the inverter board may not be attached to the reinforcing portion.

(8) In the above embodiments, the reinforcing portion protrudes from the rear surface of the chassis. However, the reinforcing portion may protrude from the front surface of the chassis.

(9) In the above fourth embodiment, the inverter board, which is a separate member from the chassis, is the reinforcing portion. However, other member than the inverter board may be the reinforcing portion. Specifically, a metal plate subjected to a bending work may be mounted to the chassis as the reinforcing portion. This expands a possibility of the size and the position of the reinforcing portion.

(10) In the above embodiments, the connector integrally includes the lid and the housing. However, the lid and the housing may be separate members.

(11) In the above embodiments, the connector includes the lid. However, the connector without a lid may be used in the present invention.

(12) In the above embodiments, four lamp clips are spaced apart from each other in the long-side direction of the chassis. However, the number of lamp clips in the long-side direction of the chassis may be three or less, or five or more.

(13) In the above embodiments, each lamp clip includes four lamp gripping portions. However, the number of lamp gripping portions may be three or less, or five or more.

(14) In the above embodiments, the end portion of the inverter board can be inserted into or removed from the connector. However, a lead wire may be provided to extend from the connector to the rear side of the chassis, and the lead wire may be directly or indirectly connected to the inverter board.

(15) In the above embodiments, the cold cathode fluorescent tube includes the outer leads at the end portions of the glass tube, and the outer lead is connected to the connection terminal of the connector. However, a ferrule may be provided at the end portion of the glass tube and connected to the outer lead such that the ferrule is connected to the connection terminal.

(16) In the above embodiments, the straight-tube type cold cathode fluorescent tube is used. However, curved cold cathode fluorescent tube such as U-shaped cold cathode fluorescent tube may be used.

(17) In the above embodiments, the cold cathode fluorescent tube is used as the tubular light source. However, a different type of discharge tube such as a hot cathode tube may be used.

(18) The number of cold cathode fluorescent tubes is not limited to that in the above embodiments and may be suitably changed.

(19) In the above embodiments, the liquid crystal panel and the chassis are arranged in a vertical position such that the short-side direction matches the vertical direction. However, the liquid crystal panel and the chassis are arranged in a vertical position such that the long-side direction matches the vertical direction.

(20) In the above embodiments, TFTs are used as switching components of the liquid crystal display device. However, the technology described above can be applied to liquid crystal display devices including switching components other than TFTs (e.g., thin film diode (TFD)). Moreover, the technology can be applied to not only color liquid crystal display devices but also black-and-white liquid crystal display devices.

(21) In the above embodiments, the liquid crystal display device including the liquid crystal panel as a display panel is used. The technology can be applied to display devices including other types of display panels.

(22) In the above embodiments, the television device including the tuner is used. However, the technology can be applied to a display device without a tuner.

### EXPLANATION OF SYMBOLS

10: liquid crystal display device (display device), 11: liquid crystal panel (display panel), 12: backlight unit (lighting device), 14, 114, 214, 314: chassis, 14d: clip mounting hole (mounting hole), 18: cold cathode fluorescent tube (tubular light source), 18c: outer lead (external connecting portion), 19: lamp clip (light source holder), 19N: lamp clip, 19a: main body, 19b: lamp gripping portion (light source gripping portion), 19d: mounting portion, 20: lamp holder (cover member), 23: housing, 23a: light source receiving portion, 24: connection terminal, 25: lid, 26, 126, 226, 326: reinforcing portion, TV: television device

1. A lighting device comprising:
a tubular light source including an external connecting portion at an end portion thereof;
a chassis housing the tubular light source, the chassis including an end section and a middle section;
a connector mounted on the end section of the chassis and electrically connected to the external connecting portion, the connector holding an end portion of the tubular light source;
a light source holder mounted on the middle section of the chassis, the light source holder holding a middle portion of the tubular light source; and
a reinforcing portion provided on at least an area extending from the connector to the light source holder adjacent to the connector.

2. The lighting device according to claim 1, wherein the chassis integrally includes the reinforcing portion by protruding a part of the chassis.

3. The lighting device according to claim 2, wherein the reinforcing portion protrudes toward a side opposite to the tubular light source.

4. The lighting device according to claim 1, wherein the reinforcing portion has an elongated shape, and a long-side direction of the reinforcing portion matches an axial direction of the tubular light source.

5. The lighting device according to claim 4, wherein the reinforcing portion overlaps at least a part of the tubular light source in a plan view.

6. The lighting device according to claim 5, wherein the reinforcing portion has a width that is larger than a diameter of the tubular light source.

7. The lighting device according to claim 1, wherein the reinforcing portion overlaps at least a part of the light source holder adjacent to the connector in a plan view.

8. The lighting device according to claim 1, wherein the reinforcing portion overlaps at least a part of the connector in a plan view.

9. The lighting device according to claim 1, wherein the reinforcing portion extends from the connector beyond the light source holder adjacent to the connector.

10. The lighting device according to claim 1, wherein the reinforcing portion extends from a position closer to an end of the chassis than the connector to the light source holder adjacent to the connector.

11. The lighting device according to claim 9, wherein
the tubular light source includes the external connecting portion at each end portion thereof,
the connector includes two connectors, the connectors being mounted on the chassis at positions corresponding to the external connecting portions, respectively, and
the reinforcing portion extends from one of the connectors to another one of the connectors.

12. The lighting device according to claim 1, wherein
the connector includes a housing and a connection terminal, the housing including a light source receiving portion receiving the tubular light source, the connection terminal being arranged in the housing so as to be in contact with the external connecting portion.

13. The lighting device according to claim 12, wherein
the light source receiving portion has an opening, and
the connector further includes a lid configured to close the opening.

14. The lighting device according to claim 13, wherein the housing integrally includes the lid.

15. The lighting device according to claim 1, further comprising a power supply board electrically connected to the connector so as to supply power to the tubular light source,
wherein the power supply board having a plate surface that is attached to the reinforcing portion.

16. The lighting device according to claim 15, wherein the power supply board is fixed on the reinforcing portion.

17. The lighting device according to claim 1, wherein
the tubular light source includes a plurality of tubular light sources, the tubular light sources being arranged in the chassis such that the axes thereof are arranged to be parallel to each other, and
the light source holder includes a main body and a plurality of light source gripping portions, the main body extending in a direction intersecting with an axis of each of the tubular light sources, the light gripping portions protruding from the main body toward the tubular light sources and gripping the tubular light sources.

18. The lighting device according to claim 17, wherein
the reinforcing portion includes a plurality of reinforcing portions, each of the reinforcing portions being arranged to correspond to each tubular light source and extending along the axial direction of the tubular light sources,
the chassis includes a mounting hole between the reinforcing portions adjacent to each other, and
the main body of the light source holder is provided with a mounting portion, the mounting portion being inserted into the mounting hole such that an edge of the mounting hole is sandwiched between the main body and the mounting portion.

19. (canceled)

20. (canceled)

21. (canceled)

22. A display device comprising:
a lighting device according to claim 1; and
a display panel configured to provide display using light from the lighting device.

23. (canceled)

24. A television device comprising the display device according to claim 22.
